(19) United States
(12) Patent Application Publication
(10) Pub. No.: US 2007/0061874 A1
(43) Pub. Date: Mar. 15, 2007

(54) System, method and program for determining a qualified support team to handle a security violation within a computer

(75) Inventors: Gregory F. Coppola, Monroe, CT (US); Jeffrey D. Schaefer, Danbury, CT (US); Brian P. Singer, Yorktown Heights, NY (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/227,806

(22) Filed: Sep. 15, 2005

(51) Int. Cl. H04L 9/32

(52) U.S. Cl. 726/10

(57) ABSTRACT

Computer system, method and program for determining which support team to assign a security problem. Two or more of the following determinations are made: (a) determining if the support team has responsibility for a security policy for a computer system in which the security problem resides, (b) determining if the support team has responsibility for a subsystem in which the security problem resides within the computer system, (c) determining if the support team has responsibility for a TCP or UDP port for an application associated with the security problem within the computer system, and (d) determining if the support team has responsibility for a type of the security problem by checking for predetermined key words or phrase within a text description of the security problem. The security problem can be a security policy violation or a network based vulnerability.

### FIELD OF THE INVENTION

The present invention relates generally to computer systems and networks, and more particularly to determination of a qualified support team to handle a security violation within a computer connected to a network.

### BACKGROUND OF THE INVENTION

Security of a company's computer systems and networks can be breached by exploit of security vulnerabilities over a network or failure to configure computer systems in accordance with the company's security policy.

Examples of network-based security vulnerabilities are as follows:
Application versions accessible over the network that are known to contain vulnerabilities.
Services which are accessible and configured with default passwords or strings (for example, the SNMP service responds to requests with the string “public”).
Services which appear vulnerable to buffer-overflow attacks.
Restricted directories/files/programs which are accessible from the network.

Examples of a company's official security policy are as follows:
Password requirements (for example, minimum length, alphanumeric form, change frequency).
Prohibited services which should not be running are found to be running (for example, telnet, ftp).—Proper file permissions and owners of system files (for example, /etc/passwd is world writeable).
Maximum number of failed logon attempts being too high.
   A security policy violation is a failure to abide by or implement any requirement of the official security policy.

Various security analysis programs are known today to check for security vulnerabilities and verify compliance with the company's official security policy.

Known security vulnerability scanning (“V. Scan”) programs scan systems for vulnerabilities via a network. Such programs probe target computer systems to identify which TCP or UDP ports are open/active. Then, such programs probe more deeply by analyzing the connection response or by issuing commands over the network connection to the system to identify what application is accessed via this TCP or UDP port. Then, such programs attempt a series of known exploits and attacks against the application running on this port. Then, such programs generate reports describing any violations. The reports identify the open ports/applications, the application version number, and the vulnerabilities for the application version, both the publicly known vulnerabilities and other vulnerabilities found by the exploits and attacks attempted by the program. IBM NSA program, NESSUS program, Foundstone Enterprise Scanner program and Qualys program are known vulnerability scanning programs.

Known security policy verification (“SPV”) programs typically comprise an agent program that runs on each computer system to be verified and a manager program which runs on a verification server. The agent programs collect configuration and security information from each computer system such as file permissions, user IDs, password policy, password age, registry settings, services running, installed software and version, etc. The manager program connects via a network to the agent programs and receives the security information obtained by the agent programs. The manager program compares the configuration settings and security information gathered by the agent program from each system to an official security policy (previously defined by an administrator) to identify differences between the actual security policy information and the official security policy information. If there are any differences, the manager program assigns a severity level and reports the problem to an administrator. For example, a known SPV tool identifies user ID violations. Symantec ESM program, Tivoli SCM program and IBM VSA program are known security policy verification programs.

Currently, when one of the known security analysis programs identifies a security problem, a (human) administrator determines which support team (i.e. an individual support person or group of support people) is best qualified to fix the problem. It was known for the administrator to assign the security problem to a support team (a) listed as having expertise and responsibility for the operating system of the computer system in which the security problem was identified, (b) responsible for the customer who owns or uses the application in which the security problem was identified, (c) listed as having expertise and responsibility for the type or “CVE” number of the security problem (such as CAN-2005-0063 (Microsoft Windows O/S), CAN-2005-0688 (Microsoft TCP/IP Stack), CAN-2005-0555 (Microsoft Internet Explorer) or CAN-2005-1409 (RedHat PostgreSQL Server), and/or (d)_responsible for a given file or directory of files (such as /usr/local/apache2/).

A known vulnerability management program uses a common vulnerability and exposures (“CVE”) number (i.e. an identifier for a specific security problem) output by one of the known security analysis programs to identify a qualified support team to assign a security problem. There is a table which correlates the CVE numbers to respective support teams.

A known vulnerability management program uses an IP address of the computer system where the security problem resides to identify a qualified support team to assign a security problem. There is a table which correlates the IP addresses to respective support teams.

An object of the present invention is to improve identification of a qualified support team to assign a security problem.

### SUMMARY OF THE INVENTION

The present invention resides in a computer system, method and program for determining which support team to assign a security problem. Two or more of the following determinations are made: (a) determining if the support team has responsibility for a security policy for a computer system in which the security problem resides, (b) determining if the support team has responsibility for a subsystem in which the security problem resides within the computer system, (c) determining if the support team has responsibility for a TCP or UDP port for an application associated with the security problem within the computer system, and (d) determining if the support team has responsibility for a type of the security problem by checking for predetermined key words or phrase within a text description of the security problem.

In accordance with features of the present invention, the security problem can be a security policy violation or a network based vulnerability.

### BRIEF DESCRIPTION OF THE FIGURES

FIG. 1 is a block diagram of a computer system including security analysis programs known in the art, and a security-problem assignment program according to the present invention.

FIG. 2 is a flow diagram of components of the computer system of FIG. 1 in relation to other computers being tested for security violations.

FIGS. 3(A) and 3(B) form a flow chart of the security-problem assignment program of FIG. 1.

FIG. 4 is flow chart of an alternate embodiment of the security-problem assignment program of FIGS. 3(A) and 3(B).

### DETAILED DESCRIPTION OF THE PREFERRED EMBODIMENTS

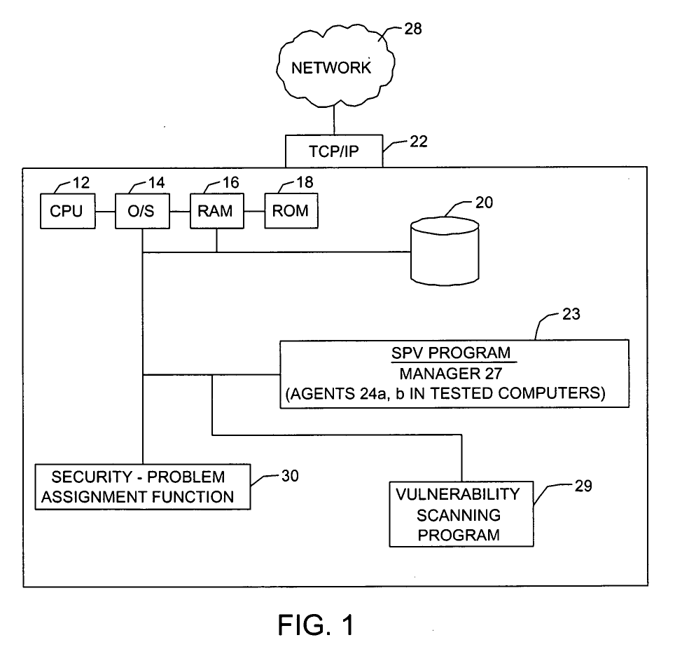

The present invention will now be described in detail with reference to the figures. FIG. 1 illustrates a computer system 10 including known CPU 12, operating system 14, RAM 16, ROM 18, storage 20, and TCP/IP adapter (or other network) card 22. Computer system 10 also includes known security analysis programs such as security policy verification program 23 and vulnerability scanning program 29 which identify security vulnerabilities and noncompliance with the company's security policy, as follows.

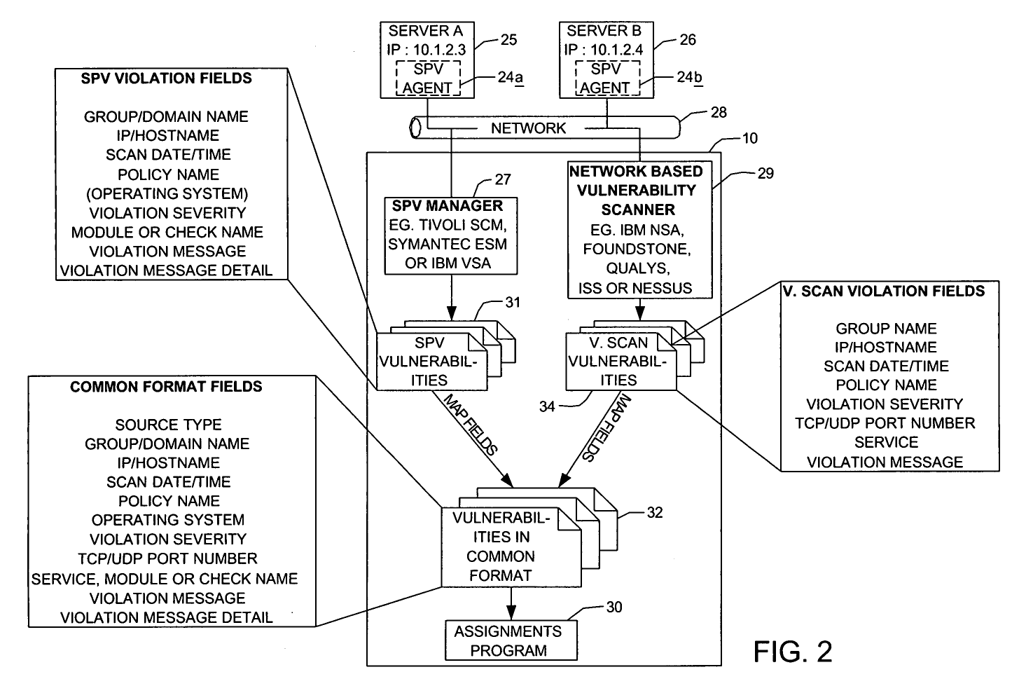

As illustrated in FIG. 2, known security policy verification program 23 includes agent programs 24a and 24b that run on computer systems 25 and 26 to be verified and a manager program 27 which runs on computer system 10. The agent programs collect security information from each computer system such as file permissions, user IDs, password policy, password age, registry settings, services running, installed software and version, etc. The manager program 27 connects via a network 28 to the agent programs 24a and 24b and receives the security information obtained by the agent programs. The manager program 27 compares the actual security policy information gathered by the agent program from each system to an official security policy (previously defined by an administrator) to identify differences between the actual security policy information and the official security policy information. If there are any differences, the manager program assigns a severity level and compiles the security policy vulnerabilities 31 in a consolidated, common format report 32. Symantec ESM program, Tivoli SCM program and IBM VSA program are examples of such known security policy verification programs.

Known security policy verification program 23 reports the following information pertaining to a security policy verification problem: group/domain name of computer 25 or 26 in which the problem resides, IP address/host name of computer 25 or 26 where problem resides, date and time that the security policy verification scan was performed, name of the security policy on the manager against which the settings were compared, operating system of the computer 25 or 26 where the problem resides, severity level of the problem, program module/subsystem (or compliance check data indicative of program module/subsystem) in computer 25 or 26 where the problem resides, a high level violation message, such as “User password never expires”, describing the problem and a more detailed violation message such as “user: jsmith”. The group/domain name identifies the computer 25 or 26 where the problem resides, by owner name, geographic location or the computer 25 or 26, name of operating system within computer 25 or 26, and whether the computer 25 or 26 is connected to the Internet.

Also as illustrated in FIG. 2, known vulnerability scanning (“V. Scan”) program 29 scans computer systems 25 and 26 for vulnerabilities via network 28. Program 29 probes target computer systems to identify which TCP or UDP ports are open/active. Then, program 29 probes more deeply (by analyzing the connection response or by issuing commands over the network connection to the system) to identify what application is accessed via each open/active TCP or UDP port. Then, program 29 attempts a series of known exploits and attacks against the application at each open/active TCP or UDP port. Then, program 29 generate a vulnerability report 34 describing each security vulnerability violation. Each report 34 identifies the open port/application, the application version number, and the vulnerabilities for the application version, both the publicly known vulnerabilities and other vulnerabilities found by the exploits and attacks attempted by program 29. IBM NSA program, NESSUS program, Foundstone Enterprise Scanner program and Qualys program are examples of such known vulnerability scanning programs.

Known vulnerability scanning program 29 reports the following information pertaining to a security policy verification problem: group name of computer 25 or 26 in which the problem resides, IP address/host name of computer 25 or 26 where problem resides, date and time that the vulnerability scan was performed, name of security policy recorded in the computer 25 or 26 where the problem resides, severity level of the problem, TCP or UDP port of computer 25 or 26 where the vulnerability resides, name of application or service at the vulnerability TCP or UDP port, and a high level violation message describing the problem such as “Server exits on large number of environment variables after username (/bin/login)”. The group name identifies the computer 25 or 26 where the problem resides, by owner name, geographic location of the computer 25 or 26, name of operating system within the computer 25 or 26, and whether the computer 25 or 26 is connected to the Internet.

The reports from security policy verification program 23 and vulnerability scanning program 29 are consolidated and converted to a common format in report 32. In addition, report 32 includes a “source” type for the security problem. The “source” type indicates the tool which found the problem such as “ESM” or “NSA” program.

Computer system 10 also includes a security-problem assignment program 30 according to the present invention. To setup for use of program 30 to assign security problems to a support team, a (human) administrator enters the following information, to the extent relevant, via program 30 for each support team (i.e. an individual support person or group of support people):

operating system(s) which the team supports.

security policy(ies) which the team supports.

program modules or subsystems which the team supports.

TCP ports and/or UDP ports for applications supported by the team.

application-created user IDs supported by the team. (These user IDs are created for a systems administrator or administrator to access the application.)

keywords/phrases (describing the security problem) supported by the team.

IP addresses or host names of computer systems supported by the team.

organization level, i.e. primary, secondary or tertiary.

e-mail contact information for each team, as well a manager for each team.

The foregoing information for each team forms a “team record”. The foregoing entries within each team record which are unrelated to the expertise of the team and tasks supported by the team need not be entered for the team. For example, if a team supports security problems where the operating system is Unix, then that need be the only information entered for this team. As another example, if a team supports security problems relating to a web server, then TCP ports such as ports 80 and 443 need be the only information entered for this team.

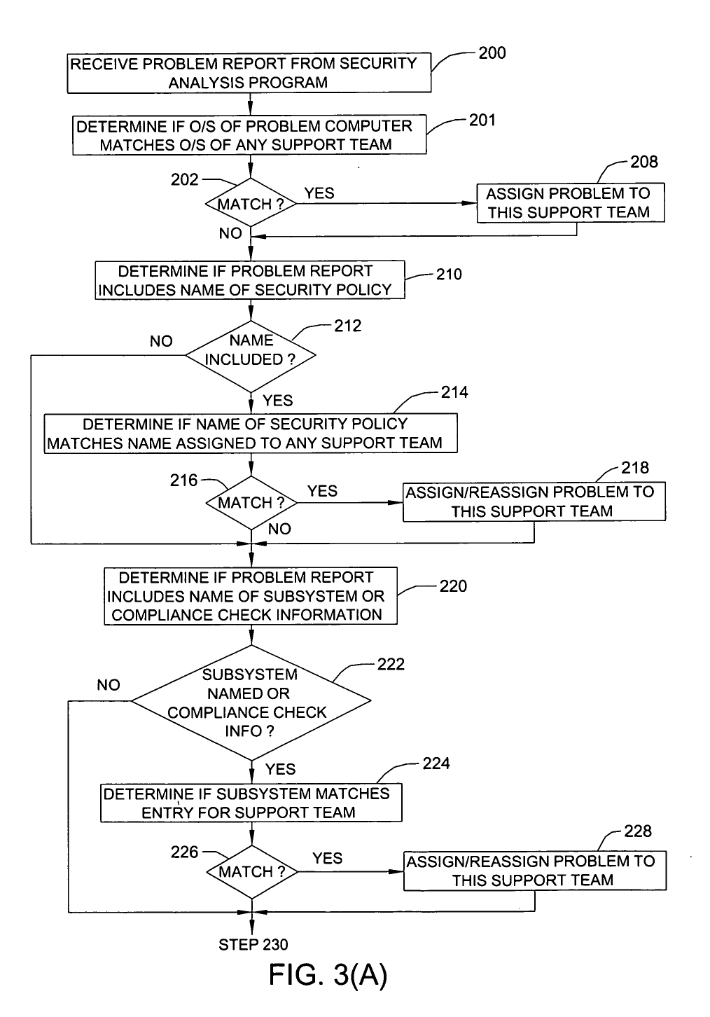

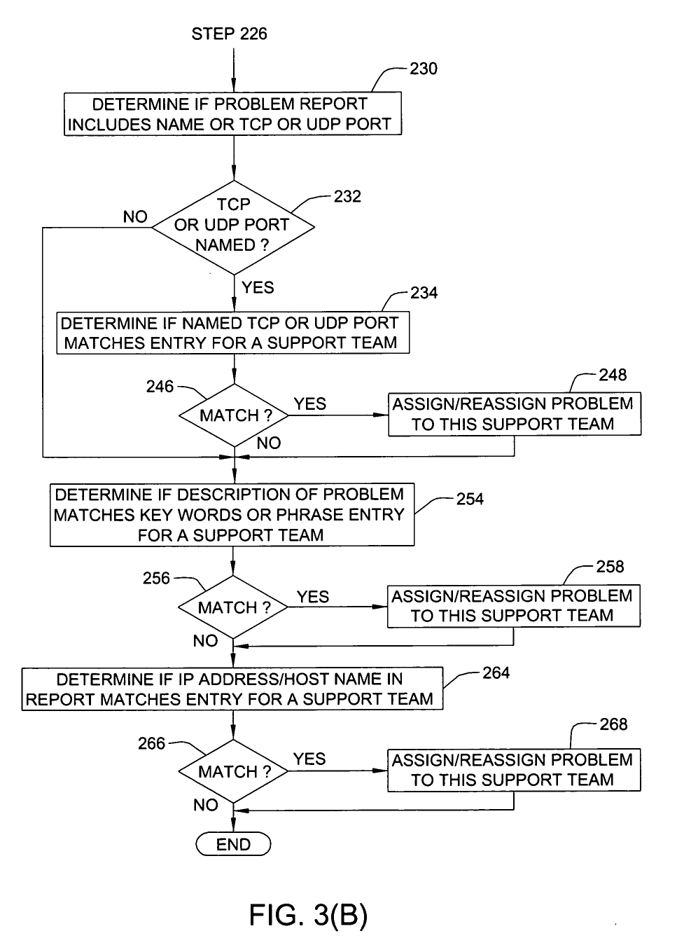

Program 30 reads the consolidated report 32 output from programs 23 and 29, and based on the report, determines which support team (from multiple support teams of a support organization) to assign each security problem for correction or other handling. FIGS. 3(A) and 3(B) illustrate the security-problem assignment program 30 in more detail. In step 200, program 30 receives information from one or more of security analysis programs 23 and 29 describing a current security problem. The information includes one or more of the following facts: operating system of the computer system in which the security problem resides, the security policy against which the computer system was compared, program module or subsystem containing the security problem within the computer system in which the security problem resides, TCP port and/or UDP port for the application/service where the security problem resides, a problematic user ID created by an application, text description or “violation message” (generated by program 23 or 29) of the security problem, IP address or host name of computer system in which the security problem resides. (The problem with the application-created user ID can be an improper form or duration of the user ID, improper permissions, invalid password settings, etc.) The description of the security policy typically includes the specific name of the policy which was used for the scan. From this information, program 30 creates a security violation record (step 200). In step 201, program 30 determines if the name of the operating system identified in the security violation record matches an operating system support entry for any of the support teams. If so (decision 202, yes branch), program 30 assigns the security problem to this support team (step 208). Program 30 assigns the security problem to this support team by opening a “problem ticket” specifying this support team to fix this problem, and then forwarding the problem ticket to this support team or making the problem ticket available through the World Wide Web. After decision 202, no branch or after step 208, program 30 determines if the security violation record contains a name of a security policy within computer 23 or 29 in which the problem was found (step 210). If so (decision 212, yes branch), program 30 determines if the name of the security policy within computer 23 or 29 in which the problem resides matches a name of a security policy support entry for any of the support teams (step 214). If so (decision 216, yes branch), then program 30 assigns the security problem to this support team (step 218). (If the security problem was assigned to a support team in step 208, then program 30 reassigns the security problem to the support team identified in step 218). After decision 216, no branch or after step 218, program 30 determines if the security violation record contains a name of a subsystem or a compliance check whose failure indicates the subsystem where the problem resides (step 220). If so (decision 222, yes branch), program 30 determines if the subsystem/compliance check matches a subsystem/compliance check for any of the support teams (step 224). If so (decision 226, yes branch), then program 30 assigns the security problem to this support team (step 228). (If the security problem was assigned to a support team in step 208 or 218, then program 30 reassigns the security problem to the support team identified in step 228). After decision 226, no branch or after step 228, program 30 determines if the security violation record contains a name of a TCP or UDP port (step 230). If so (decision 232, yes branch), program 30 determines if the TCP or UDP port matches a TCP or UDP port entry for any of the support teams (decision 234). If so (decision 236, yes branch), then program 30 assigns the security problem to this support team (step 238). (If the security problem was assigned to a support team in steps 208, 218 or 228, then program 30 reassigns the security problem to the support team identified in step 238). After decision 232, no branch or after step 238, program 30 determines if the security violation record specifies a violation associated with an application-created user ID such as an improper form or duration of the user ID, improper permissions, or invalid password settings (step 240). If so (decision 242, yes branch), program 30 determines if the user ID matches a user ID entry for any of the support teams (decision 244). If so (decision 246, yes branch), then program 30 assigns the security problem to this support team (step 248). (If the security problem was assigned to a support team in steps 208, 218, 228, 238 or 238, then program 30 reassigns the security problem to the support team identified in step 248). After decision 246, no branch or after step 248, program 30 determines if the text description of the security violation record contains key words or phrases of a key word or phrase support entry for any of the support teams (decision 254). If so (decision 256, yes branch), then program 30 assigns the security problem to this support team (step 258). (If the security problem was assigned to a support team in steps 208. 218, 228, 238 or 248, then program 30 reassigns the security problem to the support team identified in step 258). After decision 256, no branch or after step 258, program 30 determines if the IP address/host name of the security violation record matches an IP address/host name support entry for any of the support teams (decision 264). If so (decision 266, yes branch), then program 30 assigns the security problem to this support team (step 268). In this embodiment of the present invention, after completion of decision 266 and step 268 if appropriate, program 30 has determined the support team to assign to fix the security problem. While the foregoing order of decisions 201, 214, 220/224, 230/234, 240/244, 254 and 264 (and corresponding order of steps 208, 218, 228, 238, 248, 258 and 268 of determining a final support team to fix the security problem) is preferred, other orders are also viable. For example, the ordering of steps 220/222/224/226/228 could be swapped with steps 230/232/234/246/248.

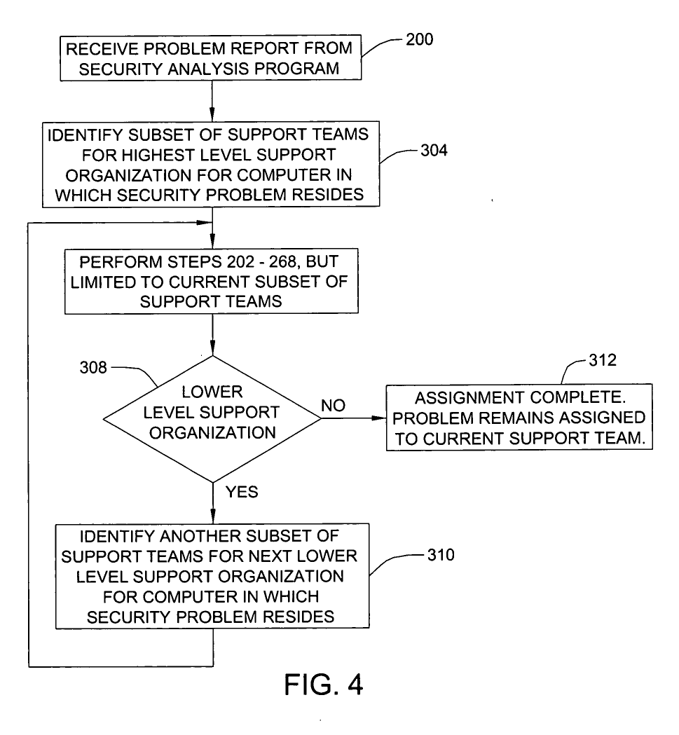

FIG. 4 illustrates an alternate embodiment of program 30, where program 30 identifies the proper support team in an iterative manner, where different subsets of support teams are considered in each iteration. In this embodiment of the present invention, the support organization is arranged in a hierarchical manner into different levels, such as primary, secondary, and tertiary levels. Different subsets of support teams are associated with each level. An administrator previously recorded which levels of the support organization are able to fix problems for particular groupings of computer systems. As described above, in step 200, program 30 receives information from one or more of security analysis programs 23 and 29 describing a current security problem. Next, program 30 identifies a highest level in the support organization to fix the security problem in the computer system in which the problem resides (step 302). Next, program 30 identifies the subset of support teams (and corresponding team records) associated with this highest level in the support organization (step 304). Next, program 30 initiates steps 202-268 described above to identify a support team from this subset of support teams (step 306). Next, program 30 identifies the sub-organization, one hierarchical level below the highest level identified in step 304, that is authorized to support the computer system in which the security problem resides (decision 308 and step 310). Next, program 30 repeats steps 202-268 to identify a support team within the sub-organization. Program 30 repeats steps 202-268 for each subset of support teams within other, lower sub-organizations until no additional sub organizations are found. After completing the last iteration of the steps of FIG. 4, program 30 selects the last support team identified as the support team to correct or otherwise handle the security problem (step 312).

Both embodiments of program 30 can be loaded into computer 10 from a computer readable media such as magnetic tape or disk, optical disk, DVD, or network media (via TCP/IP adapter card 22).

Based on the foregoing, systems, methods and programs for assigning a security problem to a qualified support team have been disclosed. However, numerous modifications and substitutions can be made without deviating from the scope of the present invention. Therefore, the present invention has been disclosed by way of illustration and not limitation, and reference should be made to the following claims to determine the scope of the present invention.

What is claimed is:

1. A method for determining a support team to assign a security problem, said method comprising at least two of the following steps:
determining if the support team has responsibility for a security policy for a computer system in which the security problem resides;
determining if the support team has responsibility for a subsystem in which said security problem resides within said computer system;
determining if the support team has responsibility for a TCP or UDP port for an application associated with said security problem within said computer system; and
determining if the support team has responsibility for a type of said security problem by checking for predetermined key words or phrase within a text description of said security problem.

2. A method as set forth in claim 1 wherein said method comprises at least three of the determining steps.

3. A method as set forth in claim 1 wherein said method comprises all of the determining steps.

4. A method as set forth in claim 1 wherein said security problem is a security policy violation.

5. A method as set forth in claim 1 wherein said security problem is a network based vulnerability.

6. A method as set forth in claim 1 further comprising the step of:
determining if the support team has responsibility for a user-id associated with said security problem within said computer system.

7. A system for determining a support team to assign a security problem, said system comprising at least two of the following determining means:
means for determining if the support team has responsibility for a security policy for a computer system in which the security problem resides;
means for determining if the support team has responsibility for a subsystem in which said security problem resides within said computer system;
means for determining if the support team has responsibility for a TCP or UDP port for an application associated with said security problem within said computer system; and
means for determining if the support team has responsibility for a type of said security problem by checking for predetermined key words or phrase within a text description of said security problem.

8. A system as set forth in claim 7 wherein said system comprises at least three of the determining means.

9. A system as set forth in claim 7 wherein said system comprises all of the determining means.

10. A system as set forth in claim 7 wherein said security problem is a security policy violation.

11. A system as set forth in claim 7 wherein said security problem is a network based vulnerability.

12. A system as set forth in claim 7 further comprising:
means for determining if the support team has responsibility for a user-id associated with said security problem within said computer system.

13. A computer program product for determining a support team to assign a security problem, said computer program product comprising:
a computer readable medium; and
further comprising at least two of the following program instructions:
first program instructions to determine if the support team has responsibility for a security policy for a computer system in which the security problem resides;
second program instructions to determine if the support team has responsibility for a subsystem in which said security problem resides within said computer system;
third program instructions to determine if the support team has responsibility for a TCP or UDP port for an application associated with said security problem within said computer system; and
fourth program instructions to determine if the support team has responsibility for a type of said security problem by checking for predetermined key words or phrase within a text description of said security problem; and wherein
said at least two of said first, second, third, and fourth program instructions are stored on said medium.

14. A computer program product as set forth in claim 13 wherein said computer program product comprises at least three of said program instructions; and wherein
said at least three of said first, second, third, and fourth program instructions are stored on said medium.

15. A computer program product as set forth in claim 13 wherein said computer program product comprises all of said program instructions; and wherein
said all of said first, second, third, and fourth program instructions are stored on said medium.

16. A computer program product as set forth in claim 13 wherein said security problem is a security policy violation.

17. A computer program product as set forth in claim 13 wherein said security problem is a network based vulnerability.

18. A computer program product as set forth in claim 13 further comprising:
fifth program instructions to determine if the support team has responsibility for a user-id associated with said security problem within said computer system; and wherein
said fifth program instructions are stored on said medium.
